(19) United States
(12) Patent Application Publication
(10) Pub. No.: US 2023/0296828 A1
(43) Pub. Date: Sep. 21, 2023

(54) OPTICAL FIBER AND ITS CONNECTION METHOD

(71) Applicant: NIPPON TELEGRAPH AND TELEPHONE CORPORATION, Tokyo (JP)

(72) Inventors: Hidenobu HIROTA, Musashino-shi, Tokyo (JP); Takui UEMATSU, Musashino-shi, Tokyo (JP); Hiroyuki IIDA, Musashino-shi, Tokyo (JP); Takashi EBINE, Musashino-shi, Tokyo (JP)

(73) Assignee: NIPPON TELEGRAPH AND TELEPHONE CORPORATION, Tokyo (JP)

(21) Appl. No.: 18/013,113

(22) PCT Filed: Jul. 6, 2020
(86) PCT No.: PCT/JP2020/026481

§ 371 Date: Dec. 27, 2022

(51) Int. Cl. G02B 6/02; G02B 6/245

(52) U.S. Cl. CPC G02B 6/02395; G02B 6/245

(57) ABSTRACT

An object of the present disclosure is to enable an optical signal propagating through a core of an optical fiber to enter and exit without bending the optical fiber.

The optical fiber of the present disclosure includes: a core; a cladding layer having a refractive index lower than a refractive index of the core; and a coating layer that coats an outer periphery of the cladding layer, in which the cladding layer includes: a first cladding portion of which main component is the same as that of the core; and a second cladding portion of which main component is different from the main component of the first cladding portion, and is softer than the first cladding portion, and an interface between the first cladding portion and the second cladding portion is in contact with the core.

### TECHNICAL FIELD

The present disclosure relates to a technology to allow an optical signal to be input and output.

### BACKGROUND ART

As illustrated in FIG. 1, the optical fiber has a three-layered structure in which a glass portion includes a core glass 111 and a cladding glass 112 covering the periphery of the core glass, and a coating 113 to protect the glass portion. The core glass 111 is mainly composed of pure quartz glass, and contains germanium dioxide as an additive. The addition of germanium dioxide increases the refractive index. On the other hand, since the cladding glass 112 is composed of pure quartz glass only, the cladding glass 112 is designed to have a refractive index lower than that of the core glass 111. Since the core glass 111 and the cladding glass 112 have the different refractive indexes, total reflection occurs at the interface therebetween, and an optical signal propagates in the core.

For optical communication, a device 91-1 and a device 91-2 are installed at both ends of an optical fiber 92 as illustrated in FIG. 2. Optical communication is established by outputting an optical signal from such devices and recognizing the devices via the optical fiber 92. This principle is used to provide services such as the Internet and telephone communication to customers. In a case where the device 91-3 is newly connected (FIG. 3A), the optical fiber 92-1 is cut off (FIG. 3B), and a bifurcated splitter 93 capable of separating signals is attached (FIG. 3C). As shown in FIG. 3A, optical signals are output from the devices 91-1 and 91-2 to keep the communication being established. As shown in FIG. 3B, the optical fiber 92-1 is cut off, and thus the optical signals output from the devices 91-1 and 91-2 are stopped. When the devices 91-1, 91-2 and 91-3 are connected using the bifurcated splitter 93, the optical signal can be transmitted from and received by each device for the first time (FIG. 3D). In other words, it is necessary to cut off the optical fiber in order to attach a new device (corresponding to the device 91-3 in FIGS. 3) in the optical communication. Disconnecting the optical fiber means that the communication should be halted between the device 91-1 and the device 91-2, during which the service cannot be provided to the user.

It is inconvenient for the user to disconnect the optical fiber and stop the service to install a new device. Actual wiring will be described referring to FIG. 4. FIG. 4 illustrates a wiring formation for providing the service. An optical line terminal (OLT) 82 is installed in a communication building, and an optical network unit (ONU) 81 is installed at a user’s home. The OLT 82 and the ONU 81 correspond to the device 91-1 and the device 91-2, respectively. For connecting the OLT 82 and the ONU 81, an integrated distribution module (IDM) 83 is used in the communication building, and an optical fiber cable 84 and an 8-branch splitter 85 are used outside the communication building. While FIGS. 3 illustrates the splitter 93 that divides the communication into two segments, the 8-branch splitter 85 is used in FIG. 4. Although FIG. 4 illustrates an example in which there is the single ONU 81, that is, only one user is wired, a plurality of ONUs 81 can be connected to the single OLT 82.

A position where the 8-branch splitter 85 is disposed is determined on the basis of a place requested by the user or a place expected that the user would make a request. The 8-branch splitter 85 can accommodate up to 8 users, but in such a system, it is very rare to get 8 users. If it is not used, it is wasted.

Therefore, it is required to take out the optical signal propagating through the core of the optical fiber to the outside of the optical fiber, or to put the optical signal into the core from the outside of the optical fiber at anytime and anywhere without using a splitter and stopping communication.

Therefore, we have proposed a method of inputting and outputting optical signals without using a splitter (see Patent Literature 1 & Non Patent Literature 1). The optical fiber is bent, and an optical fiber probe is disposed in the vicinity of the bent portion. It is the principle of coupling optical signals between the optical fiber bent portion and the probe. That is, the optical fiber is bent and light leaks from the bent portion, but the leak light is received by the probe fiber in the optical communication propagating through the core of the optical fiber. In addition, the optical signal output from a tip of the probe fiber is coupled to the core of the bent optical fiber. Therefore, the optical signal is simultaneously input and output between the bent fiber and the probe.

### CITATION LIST

### Patent Literature

Patent Literature 1: Japanese Patent No. 6122785

### Non Patent Literature

Non Patent Literature 1: H. Hirota, T. Kawano, M. Shinpo, K. Noto, T. Uematsu, N. Honda, T. Kiyokura, and T. Manabe, “Optical Cable Changeover Tool With Light Injection and Detection Technology,” Journal of Lightwave Technology, Vol. 34, No. 14, pp. 3379-3388, 2016.
Non Patent Literature 2: Masao Tatsuzo, “Calculation of Mechanical Reliability for Optical Fiber Bent in Harsh Environment”, IEICE Transactions on Communications (Japanese Edition), B, Vol. J94-B, no.6, pp.738-746, 2011.

### SUMMARY OF INVENTION

### Technical Problem

Challenges faced by the method using the bent optical fiber and the probe fiber will be described. The vast number of cracks occurs on the glass surface in the optical fiber upon manufacturing. When the optical fiber is bent and left for a long time, the cracks grow and the optical fiber itself breaks (see Non Patent Literature 2). Therefore, the method of bending the optical fiber can be used to only a test or work that can be performed in a short time.

Consequently, an object of the present disclosure is to enable an optical signal propagating through a core of an optical fiber to enter and exit without bending the optical fiber.

### Solution to Problem

In order to achieve the object stated above, an optical fiber according to the present disclosure includes a core and a cladding layer, in which a part of the cladding layer is replaced with a resin material peelable from core glass and cladding glass. In a connection method for the optical fiber of the present disclosure, cores of two optical fibers from each of which the resin material is peeled off are brought into contact with each other to connect the optical fibers.

In particular, the optical fiber of the present disclosure includes:
a core;
a cladding layer having a refractive index lower than a refractive index of the core; and
a coating layer that coats an outer periphery of the cladding layer,
in which the cladding layer includes:
   a first cladding portion of which main component is the same as that of the core; and
   a second cladding portion of which main component is different from the main component of the first cladding portion, and is softer than the first cladding portion, and
   an interface between the first cladding portion and the second cladding portion is in contact with the core.

In particular, the optical fiber connection method of the present disclosure includes:
removing a part of the coating layer in a longitudinal direction of the two optical fibers as set forth in the present disclosure;
removing the second cladding portions of the two optical fibers from the removed coating layers to expose the cores; and
bringing the exposed cores of the two optical fibers into contact with each other.

### Advantageous Effects of Invention

According to the present disclosure, the optical signal propagating through the core can be easily input and output without bending the optical fiber, and it is also possible to avoid breakage of the optical fiber due to bending for a long time.

### BRIEF DESCRIPTION OF DRAWINGS

FIG. 1 illustrates an example of a structure of an optical fiber.

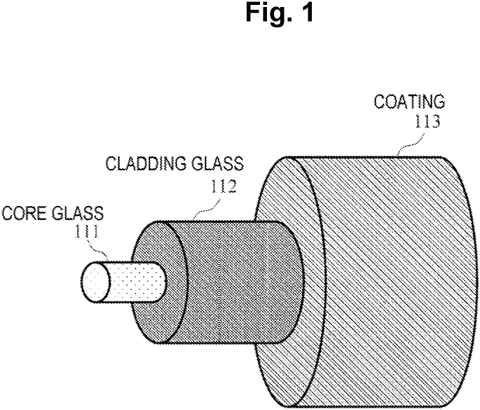

FIG. 2 illustrates an example of a configuration of optical communication.

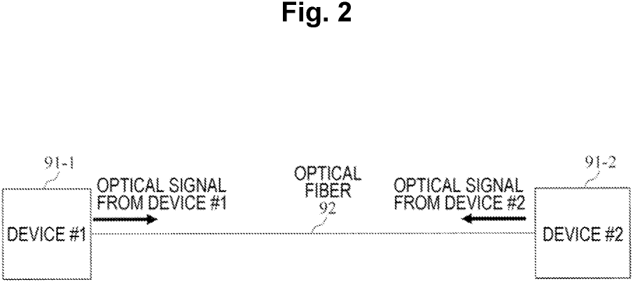

FIG. 3A is a first view illustrating an optical fiber connection method related to the present disclosure.

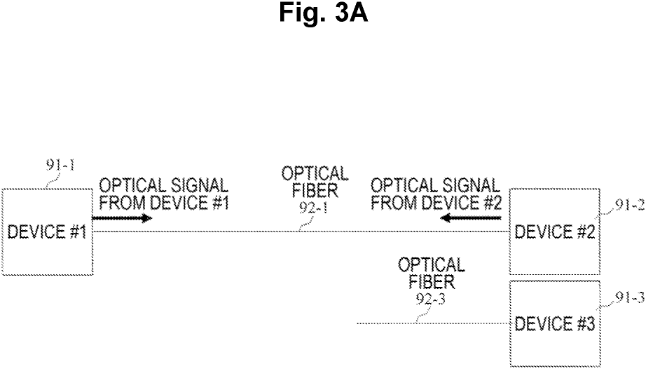

FIG. 3B is a second view illustrating the optical fiber connection method related to the present disclosure.

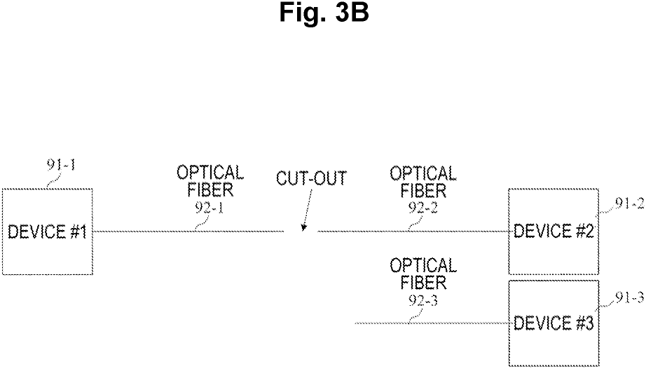

FIG. 3C is a third view illustrating the optical fiber connection method related to the present disclosure.

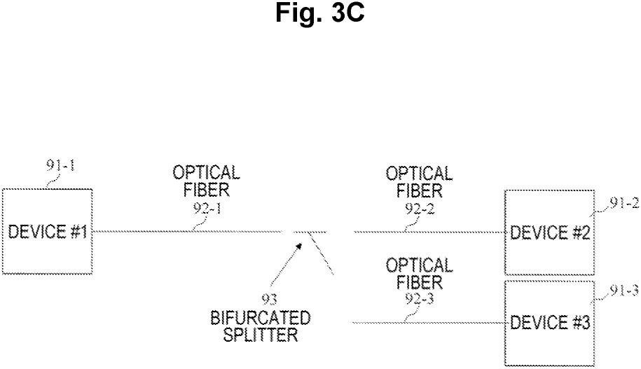

FIG. 3D is a fourth view illustrating the optical fiber connection method related to the present disclosure.

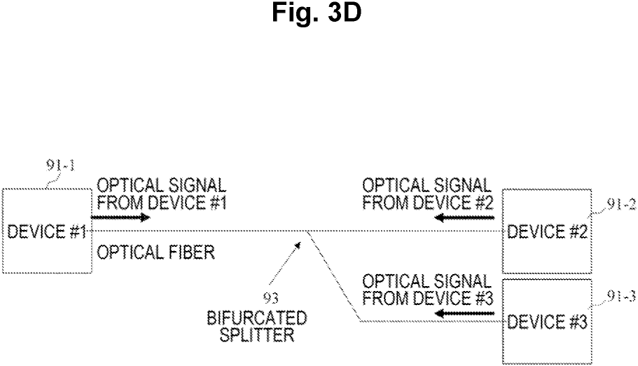

FIG. 4 illustrates an example of wiring using an 8-branch splitter.

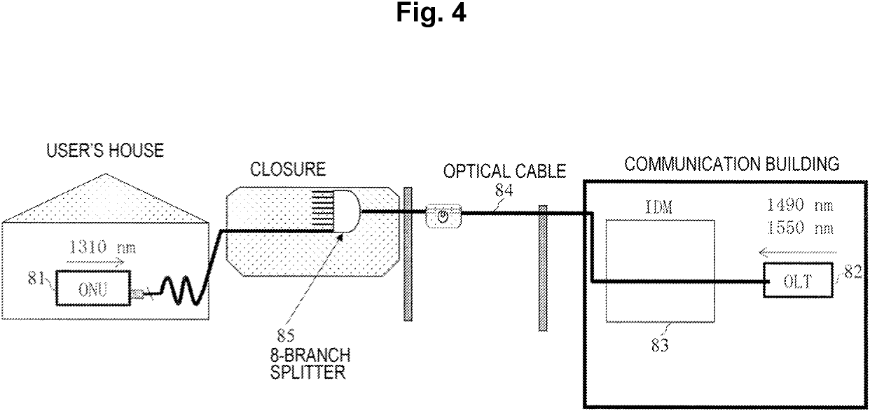

FIG. 5 is a cross-sectional view illustrating a configuration example of the optical fiber according to a first embodiment.

FIG. 6 is an explanatory diagram illustrating an example of a light propagation in the optical fiber of the present disclosure.

FIG. 7A illustrates an example of the optical fiber from which a coating layer has been removed.

FIG. 7B illustrates an example of the optical fiber from which a second cladding portion has been removed.

FIG. 8 is an explanatory diagram illustrating an example of a method of outputting an optical signal using the optical fiber of the present disclosure.

FIG. 9 is an explanatory diagram illustrating an example of a method of inputting the optical signal using the optical fiber of the present disclosure.

FIG. 10 is a cross-sectional view illustrating a configuration example of a first optical fiber according to a second embodiment.

FIG. 11 illustrates an example of the optical fiber from which the second cladding portion has been removed.

FIG. 12 is a cross-sectional view illustrating a configuration example of a second optical fiber according to the second embodiment.

FIG. 13 illustrates an example of the optical fiber from which the second cladding portion has been removed.

FIG. 14 illustrates an example of a state in which the optical fiber is connected.

FIG. 15 is a cross-sectional view illustrating a configuration example of the optical fiber according to the present disclosure.

### DESCRIPTION OF EMBODIMENTS

Embodiments of the present disclosure will be described in detail below with reference to the drawings. Note that the present disclosure is not limited to the following embodiments. These embodiments are merely examples, and the present disclosure can be carried out in a form with various modifications and improvements based on the knowledge of those skilled in the art. Note that components having the same reference numerals in the present specification and the drawings indicate the same components.

### First Embodiment

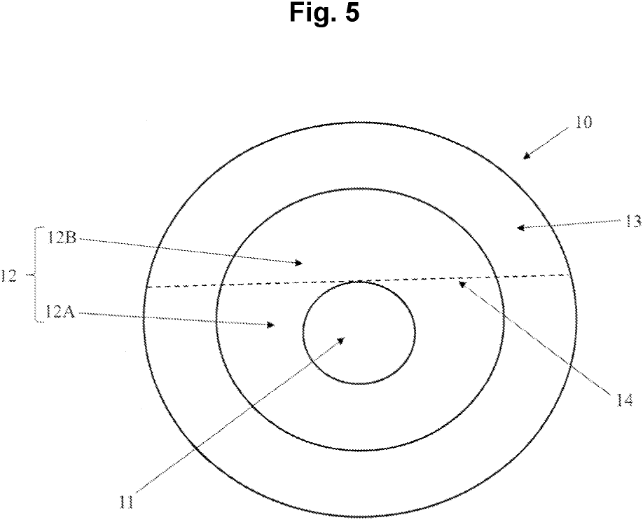

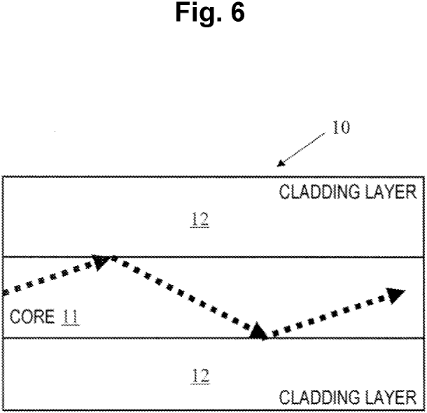

A structure of the optical fiber will be described in Example 1. FIG. 5 is a cross-sectional view illustrating an example of the optical fiber according to the present disclosure. A core 11 is provided at the center, and a periphery thereof is covered with the cladding layer 12. An outer side in contact with the cladding layer 12 is coated with a coating layer 13. Comparing the refractive index of the core 11 with the refractive index of the cladding layer 12, the core 11 has the higher refractive index. Accordingly, an optical signal is propagated through the core 11 of the optical fiber as illustrated in FIG. 6 by causing reflection on surfaces of the core 11 and the cladding layer 12. FIG. 6 is a cross-sectional view in a longitudinal direction of the optical fiber, in which a broken line indicates the optical signal.

The cladding layer 12 of the present invention includes two cladding portions 12A and 12B having different materials. A main component of the first cladding portion 12A is the same glass material as the core 11, and a main component of the other cladding portion 12B is a material other than the glass material. Examples of the material other than glass included in the cladding portion 12B include a polymer resin and an acrylic resin, and any materials having a predetermined refractive index. In the present disclosure, the cladding portion 12A may be referred to as a first cladding portion or glass cladding, and the cladding portion 12B may be referred to as a second cladding portion.

The refractive index of the cladding layer 12 will be described. In order to propagate light through the core 11, the refractive index of the core 11 needs to be higher than the refractive index of the cladding layer 12. The cladding layer 12 is made of two different materials, but the refractive indexes of the two cladding portions 12A and 12B need to be lower than the refractive index of the core 11. It is desirable that the refractive indexes of the two cladding portions 12A and 12B are the same, but even if the refractive indexes are approximate because they are made of different materials, reflection occurs between the core 11 and the cladding layer 12, and thus sufficient effect can be obtained.

The optical fiber of the present disclosure can be manufactured using a known drawing process. When drawing, a glass rod, which is a base material of the optical fiber, is placed under a high-temperature environment of 1000° C. or higher to melt and pull the glass to make the thin glass. For the optical fiber of the present invention, for example, a preform for forming the core 11 and the glass cladding 12A is thinned by drawing. At this time, an interface 14 is formed in the cladding layer of an optical fiber strand drawn from a drawing apparatus. The interface 14 is a surface having any shape that can expose at least a part of the core 11, and is, for example, a flat surface. A gel-like substance having a refractive index substantially the same as that of the glass cladding 12A is applied onto the interface 14. Accordingly, a strand in which the outer periphery of the core 11 is covered with the cladding layer 12 is produced. The periphery of the cladding layer 12 is coated with the coating layer 13. Accordingly, the optical fiber of the present disclosure can be manufactured.

### Second Embodiment

In the present embodiment, a method for extracting the optical signal propagating through the core 11 of the optical fiber to the outside of the optical fiber will be described. FIG. 5 is a cross-sectional view illustrating an example of the optical fiber of the present disclosure. The core 11 and the glass cladding 12A are integrated and are not peeled off from each other. The cladding portion 12B is made of a different material other than glass, which is a liquid or a gel-like soft substance, thus the cladding portion 12B is not integrated with the core 11, that is, easily peeled off.

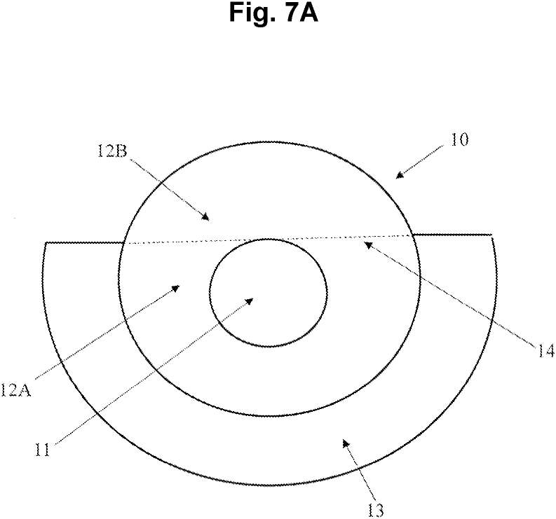

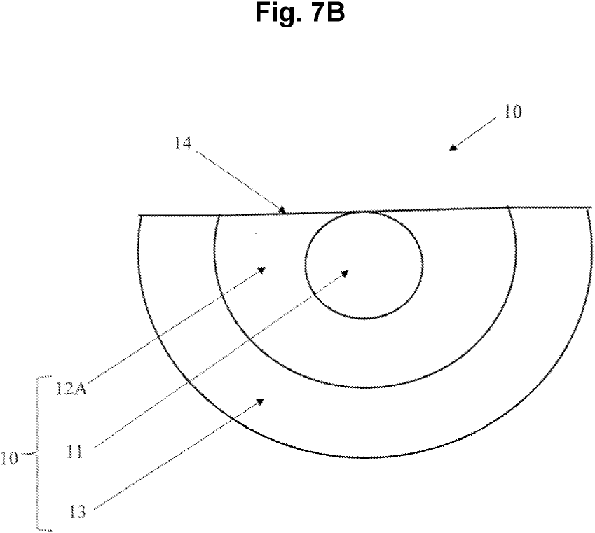

A peeling method is shown in FIGS. 7. As illustrated in FIG. 7A, the coating layer 13 is peeled off so that the cladding portion 12B made of the material other than glass is exposed. The cladding layer 12 is exposed under the coating layer 13; since the cladding portion 12B is made of the soft material, it can be wiped with, for example, a cotton swab. Further, the cladding portion 12B can be completely removed by cleaning with ethanol. Accordingly, as illustrated in FIG. 7B, the flat interface 14 is formed, and the core 11 is exposed at the center thereof.

In the optical fiber 10 of the present disclosure, the interface 14 is in contact with the core 11. When the cladding portion 12B is removed from the cladding layer 12, a portion of the cladding portion 12B in contact with the core 11 does not reflect the light of the core 11. Therefore, the optical signal propagating through the core 11 of the optical fiber 10 can enter and exit.

### Third Embodiment

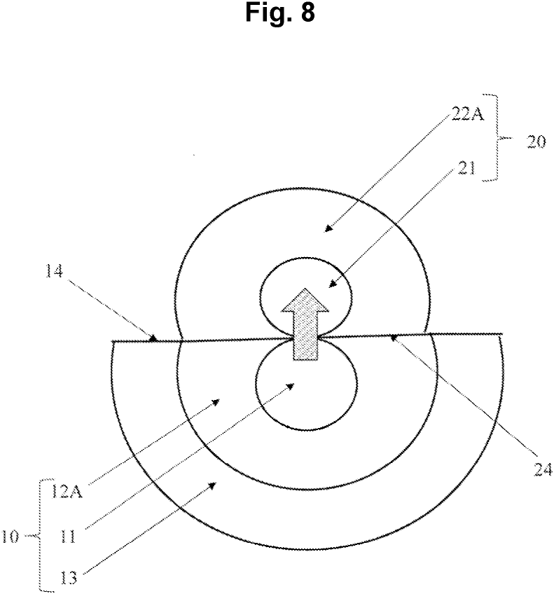

FIG. 8 illustrates a method for extracting the optical signal. In the present embodiment, optical fibers 10 and 20 are used. The optical fibers 10 and 20 have the same configuration as the optical fiber 10 as illustrated in FIGS. 7. The lower optical fiber 10 is the same as in FIG. 7B, and the interface 14 is formed. For taking out the optical signal, the optical fiber 20 is prepared in which a core 21 and a glass cladding 22A are the same as the core 11 and glass cladding 12A shown in FIG. 7B and an interface 24 is exposed. When the two optical fibers 10 and 20 are arranged such that the cores 11 and 21 are in contact with each other, the optical signal leaks from a polished side of the core 11 to a core 21 side of the attached optical fiber 20. An arrow in the drawing indicates that the optical signal is transferred from the core 11 to the core 21. Therefore, the optical signal propagating through the core 11 of the optical fiber can take out to the core 21.

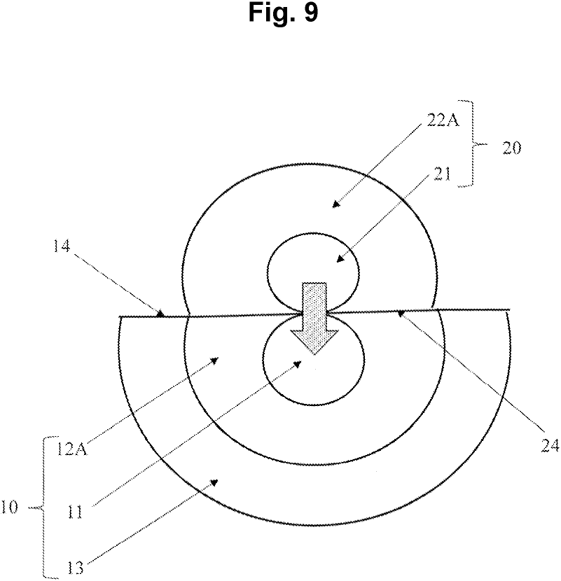

FIG. 9 is drawn on the assumption that that the optical signal is propagated to the core 21. As in FIG. 8, the optical signal propagates from the core 21 to the core 11. That is, the optical signal can be put into the optical fiber from the outside.

Although FIG. 8 illustrates that the optical signal is taken out and FIG. 9 illustrates that the optical signal is put into the optical fiber, when the optical signal is simultaneously put into each of the cores 11 and 21, the emission and exit of the optical signal can be simultaneously performed.

### Fourth Embodiment

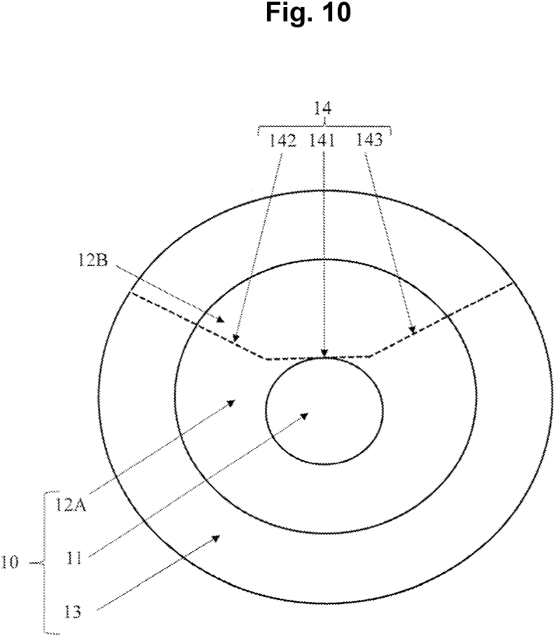

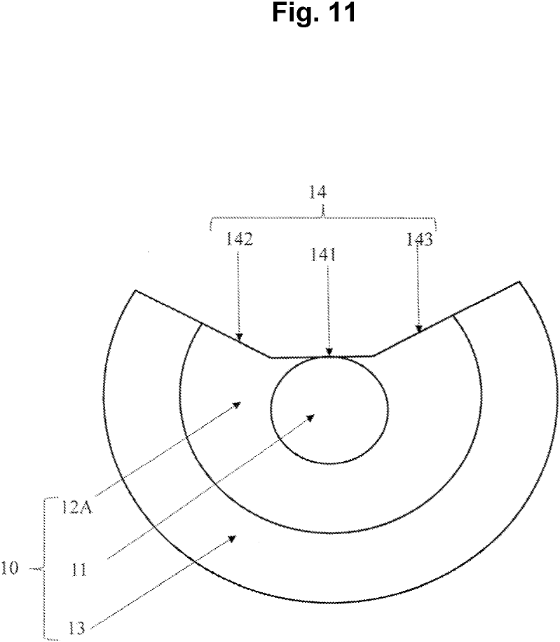

As illustrated in FIGS. 7, in a case where the interface 14 of the optical fiber 10 is a flat surface, it is difficult to recognize the exposed portion of the core 11. In the present embodiment, the interface 14 has a groove structure as illustrated in FIG. 10. In particular, the interface 14 includes a bottom surface 141 that is in contact with the core 11, and side surfaces 142 and 143 adjacent to the bottom surface 141. In the present embodiment, the coating layer 13 is removed along the side surfaces 142 and 143 when connecting with the optical fiber 20 as illustrated in FIG. 11.

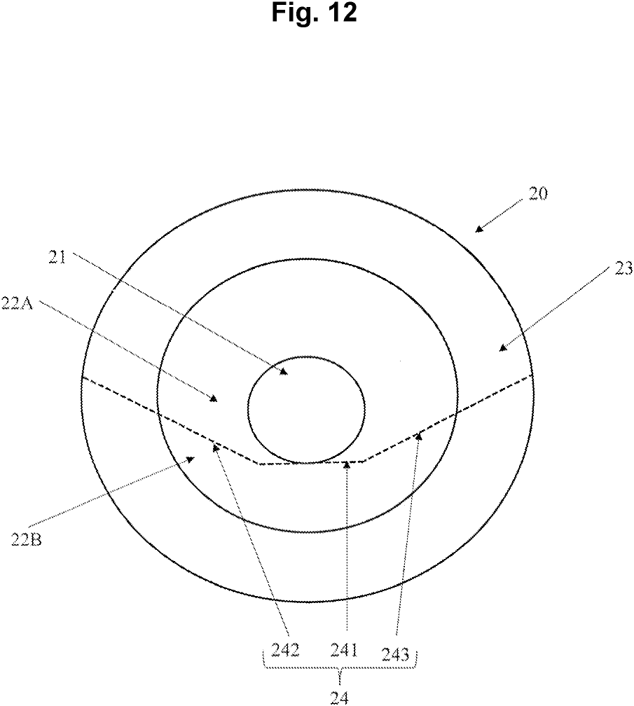

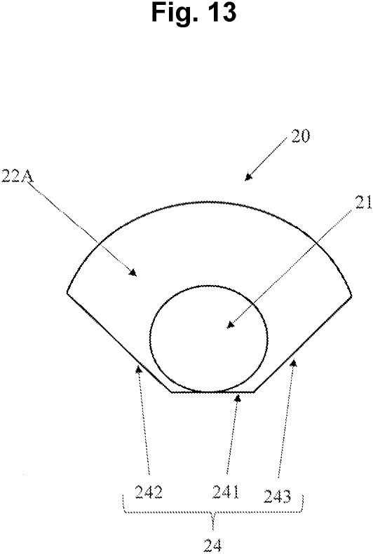

FIG. 12 illustrates a structure of the optical fiber 20 to be attached. The interface is a flat surface in the description stated above, but the interface 24 is angled so as to be aligned with the interface 14 as illustrated in FIG. 10. For example, the interface 24 includes a bottom surface 241 that is in contact with the core 21, and side surfaces 242 and 243 adjacent to the bottom surface 241. In the present embodiment, the coating layer 23 and a second cladding portion 22B are removed along the side surfaces 242 and 243 when connecting with the optical fiber 10 as illustrated in FIG. 13.

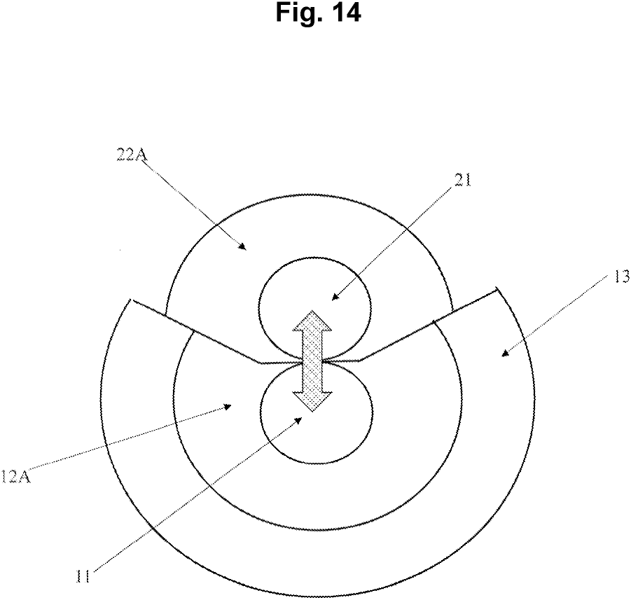

FIG. 14 illustrates an example of a state where the optical fiber 10 of FIG. 11 and the optical fiber 20 of FIG. 13 are connected to each other. The interface 14 and the interface 24 are engaged with each other. As described above, in the present embodiment, since the interfaces 14 and 24 have the groove structures, the core 11 and the core 21 match with each other. Therefore, in the present embodiment, the optical signal between the cores can be transferred to the adjacent cores without adjusting positions of the cores 11 and 21.

In the optical fiber 10 of the present embodiment, the example in which the interface 14 has a π-shape is illustrated, but other concave shapes such as a V-shape or a U-shape can be adopted. In the optical fiber 20 of the present embodiment, the example in which the interface 24 has a π-shape is illustrated, but other concave shapes such as a V-shape or a U-shape can be adopted.

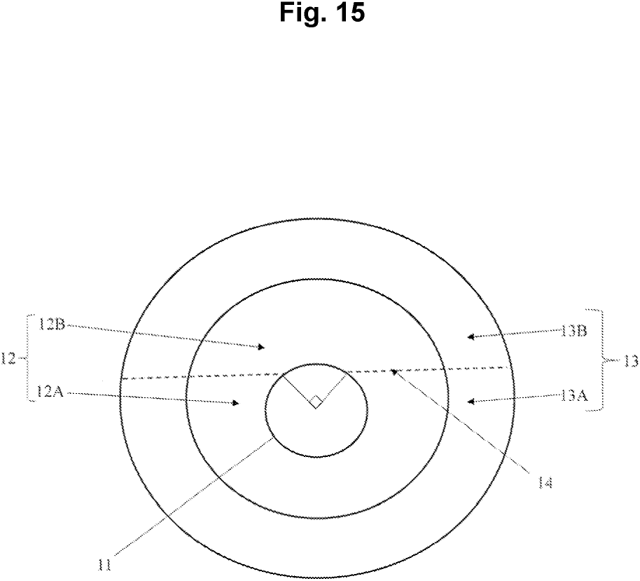

The bottom surface 141 in contact with the core 11 and the bottom surface 241 in contact with the core 21 are configured such that a surface in contact with the outer periphery of the core in the interface is a flat surface, and only one point of the outer periphery of the core is exposed in a cross-sectional view. However, any shape exposing the core 11 can be adopted as a surface in contact with the outer periphery of the core in the interface. For example, the interface 14 may be configured such that ¼ of the outer periphery of the core 11 as illustrated in FIG. 15 is exposed. However, when an area becomes larger where the core 11 and the second cladding portion 12B are in contact with each other, the loss of the optical signal propagating through the core 11 increases. Therefore, the core 11 exposed from the interface 14 is preferably less than half of the outer periphery.

As illustrated in FIG. 15, the coating layer 13 may include a coating layer 13A coating the first cladding portion 12A and a coating layer 13B coating the second cladding portion 12B. A color and a pattern of the coating layers 13A and 13B are different so that the first cladding portion 12A and the second cladding portion 12B can be identified.

### Expected Effects

As described above, optical signals have been extracted by bending optical fibers. There has been a problem of disconnection when the optical fiber is bent. By using the structure of the present invention, the optical signal propagating through the core can be taken out and put into the optical fiber without bending the optical fiber, so that the optical fiber can be installed for a long time. The conventional technology has been applied only to tests and works that can be used only in a short-time work, but the present invention does not need to bend the optical fiber, and thus can perform long-time works and tests.

Furthermore, the optical fiber of the present disclosure is easy to expose the core, and can cut the coating and the cladding layers to easily connect the optical fiber when a user wants to use the service.

Further, the 8-branch splitter has been used so far, but the 8-branch splitter is only partially used. The present disclosure also eliminates the need for the conventional 8-branch splitter.

### INDUSTRIAL APPLICABILITY

The present disclosure can be applied to the information communication industry.

Reference Signs List

| | |
|---|---|
| 10, 20 | optical fiber |
| 11, 21 | core |
| 12, 22 | cladding layer |
| 12A, 22A | first cladding portion |
| 12B, 22B | second cladding portion |
| 13 | coating layer |
| 13A | |
| 13B | |
| 14, 24 | interface |
| 81 | ONU |
| 82 | OLT |
| 83 | IDM |
| 84 | optical fiber cable |
| 85 | 8-branch splitter |
| 91-1, 91-2, 91-3 | device |
| 92 | optical fiber |
| 93 | bifurcated splitter |
| 111 | core glass |
| 112 | cladding glass |
| 113 | coating |

1. An optical fiber, comprising:
a core;
a cladding layer having a refractive index lower than a refractive index of the core; and
a coating layer that coats an outer periphery of the cladding layer,
wherein the cladding layer includes:
a first cladding portion of which main component is the same as that of the core; and
a second cladding portion of which main component is different from the main component of the first cladding portion, and is softer than the first cladding portion,
wherein an interface between the first cladding portion and the second cladding portion is in contact with the core.

2. The optical fiber according to claim 1, wherein
the main component of each of the core and the first cladding portion is pure quartz glass, and
the main component of the second cladding portion is a resin.

3. The optical fiber according to claim 2, wherein
the resin is in a gel form.

4. The optical fiber according to claim 1, wherein
the interface between the first cladding portion and the second cladding portion has a concave shape with a portion in contact with the core as a bottom surface.

5. An optical fiber connection method, comprising:
removing a part of the coating layer in a longitudinal direction of the two optical fibers as set forth in claim 1;
removing the second cladding portions of the two optical fibers from the removed coating layers to expose the cores; and
bringing the exposed cores of the two optical fibers into contact with each other.
